(19) United States
(12) Patent Application Publication
(10) Pub. No.: US 2025/0292385 A1
(43) Pub. Date: Sep. 18, 2025

(54) IMAGE INSPECTION APPARATUS, METHOD FOR IMAGE INSPECTION, AND STORAGE MEDIUM

(71) Applicant: CANON KABUSHIKI KAISHA, Tokyo (JP)

(72) Inventor: Kenji KURIBAYASHI, Kanagawa (JP)

(21) Appl. No.: 19/070,610

(22) Filed: Mar. 5, 2025

(30) Foreign Application Priority Data
Mar. 15, 2024 (JP) 2024-041589

(51) Int. Cl. G06T 7/00; H04N 1/00

(52) U.S. Cl. CPC G06T 7/0004; G06T 2207/20081; G06T 2207/30144; G06T 2207/30168; H04N 1/00005; H04N 1/00045; H04N 1/00061; H04N 1/00079

(57) ABSTRACT

An image inspection apparatus that acquires information on a corrective action performed by a user for an image anomaly, and performs training of a learning model to estimate a candidate for corrective action content from an image anomaly using the image anomaly and the acquired information on the corrective action as learning data.

### BACKGROUND OF THE INVENTION

### Field of the Invention

The present invention relates to an image inspection apparatus, a method for image inspection, and a storage medium.

### Description of the Related Art

In an image forming apparatus such as a multifunction peripheral, when an anomaly such as an error or a fault occurs, a maintenance person such as a service man is dispatched by notification of the anomaly. The maintenance person checks the manual and performs maintenance such as part replacement.

In recent years, cloud computing has been spreading. A main feature of cloud computing is that data conversion and data processing are executed in a distributed manner by using many computing resources, and requests from many clients are processed in parallel by distributed parallel processing. Use of cloud computing allows a system developer to easily procure necessary computing resources and to focus on system function development.

One of the elements having high affinity with cloud computing is artificial intelligence (AI). Core technologies implementing AI include machine learning. In machine learning, it is possible to create a learning model in which a feature (characteristic, pattern, tendency, and the like) of data is extracted by analyzing a large amount of data (big data) with a learning algorithm. Many computing resources are required to securely store and analyze such a large amount of data, and thus often introduced in a cloud computing environment. Also in the maintenance of the image forming apparatus described above, various methods have been proposed in which data collected from a plurality of image forming apparatuses is learned, and the obtained learned model is used to support maintenance work such as part replacement.

For example, Japanese Patent Laid-Open No. 2019-211940 proposes a maintenance system that designates an apparatus of a visiting destination to a worker and determines a visiting route for instructing replacement work. The proposed maintenance system specifies the worker who performs the part replacement work based on a part replacement request from a printing apparatus such as a plurality of MFPs and information on a part owned by the worker and the work status of the worker such as a service man. This enables the worker such as a service man to efficiently perform the replacement work. Japanese Patent Laid-Open No. 2019-102843 proposes an image forming apparatus that, when an image anomaly occurs, displays an example of an anomalous image, acquires selection by the user of the anomalous image, and determines a faulty portion based on the selected anomalous image.

However, since the maintenance system proposed in Japanese Patent Laid-Open No. 2019-211940 does not specify a part to be replaced from an image anomaly, replacement information and repair content information of the part for eliminating the image anomaly cannot be acquired. The image forming apparatus proposed in Japanese Patent Laid-Open No. 2019-102843 can provide the worker with a faulty portion for eliminating an image anomaly, but does not record and collect an image anomaly, a faulty portion, and a corrective action content record in association with one another. For this reason, there has not been a mechanism for inferring the faulty portion and processing content based on the faulty portion corresponding to an image anomaly and a corrective action content record.

### SUMMARY OF THE INVENTION

The present invention enables realization of an image inspection apparatus configured to use a corrective action actually performed by a user for an image anomaly, for training of a learning model for estimating corrective action content.

One aspect of the present invention provides an image inspection apparatus, comprising: an acquiring unit configured to acquire information on a corrective action performed by a user for an image anomaly; and a training unit configured to perform training of a learning model for estimating a candidate of corrective action content from an image anomaly using, as learning data, the image anomaly and the acquired information on the corrective action.

Another aspect of the present invention provides a method for image inspection, the method comprising: acquiring information on a corrective action performed by a user for an image anomaly; and performing training of a learning model for estimating a candidate of corrective action content from an image anomaly using, as learning data, the image anomaly and the acquired information on the corrective action.

Still another aspect of the present invention provides a non-transitory computer-readable storage medium, the storage medium storing a program for causing a computer to execute each step of a method of controlling an image inspection apparatus, the method comprising: acquiring information on a corrective action performed by a user for an image anomaly; and performing training of a learning model for estimating a candidate of corrective action content from an image anomaly using, as learning data, the image anomaly and the acquired information on the corrective action.

Further features of the present invention will become apparent from the following description of exemplary embodiments (with reference to the attached drawings).

### BRIEF DESCRIPTION OF THE DRAWINGS

FIG. 1 is a configuration diagram of an image inspection system for carrying out the present invention.

FIGS. 2A and 2B are hardware configuration diagrams of the image inspection system according to the present invention.

FIG. 3 is a sequence diagram of image inspection processing in one example.

FIGS. 4A and 4B are examples of a scan image including an anomaly in one example.

FIG. 5 is an example of a screen of an input device.

FIG. 6 is a software configuration diagram of an image inspection result notification server in one example.

FIG. 7A is a flowchart of overall processing of the image inspection result notification server in one example.

FIG. 7B is a flowchart of learning data collection processing of the image inspection result notification server in one example.

FIG. 8 is a flowchart of machine learning processing in one example.

FIG. 9 is a flowchart of learning data collection processing in one example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Hereinafter, data generated by the present proposal in order to create a machine learning model is called learning data, and data to be input to the created machine learning model for performing estimation is called input data. Data for retraining a created machine learning model is also called learning data, and learning includes retraining. Performing training of a learning model with learning data includes creating the learning model with the learning data and retraining the learning model with the learning data.

The image inspection apparatus of the present embodiment collects learning data including a faulty part corresponding to an image anomaly and corrective action content, creates a machine learning model using the learning data, and upon receiving an image anomaly notification of the image forming apparatus, estimates the corrective action content using the created learning model.

The user who performs the corrective action may be a maintenance person who performs the service, or may be a user of the image forming apparatus. Replacement of consumables and the like are performed not only by a maintenance person but also by a user of the image forming apparatus.

The image inspection apparatus according to the present embodiment is configured to include an image inspection result notification server 104. The image inspection apparatus may further include an image anomaly information collection server 102 and a replacement part information collection server 105. The image anomaly information collection server 102, the image inspection result notification server 104, and the replacement part information collection server 105 may have any configuration, and may be configured by one apparatus or may be configured in a distributed manner. The estimation result of the corrective action content by the image inspection apparatus is displayed on a Web based user interface (Web UI) of a portal site of an input device 103. The user views this estimation result and uses it as a reference of a corrective action to be actually performed.

### First Embodiment

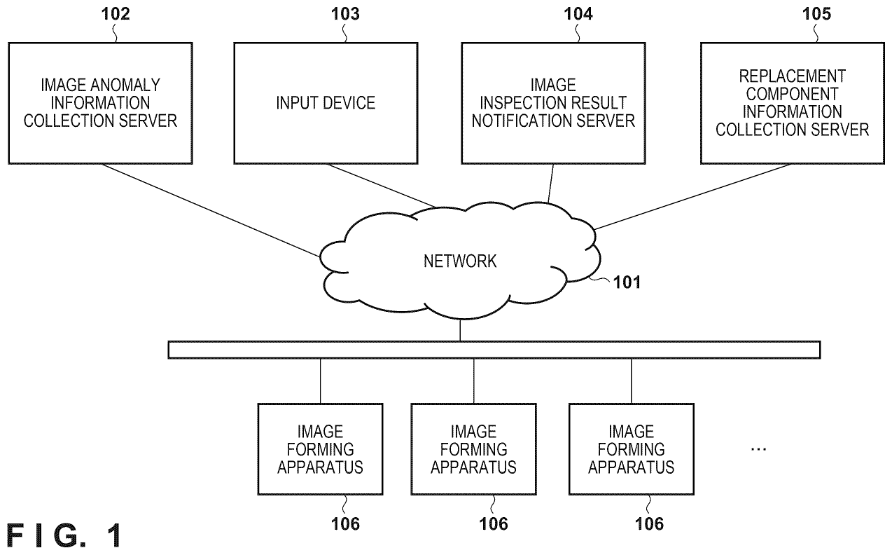

The configuration of an image inspection system that provides an image inspection service online for carrying out the present invention will be described with reference to FIG. 1. The image inspection system of the present invention includes the image anomaly information collection server 102, the input device 103, the image inspection result notification server 104, the replacement part information collection server 105, an image forming apparatus 106, and a network 101.

A plurality of the image forming apparatuses 106 are, for example, a digital multifunction peripheral, a facsimile machine, a laser beam printer, a scanner device, or the like.

The image anomaly information collection server 102 is a server that collects information from the image forming apparatus 106. Image anomaly information is collected and accumulated from the plurality of image forming apparatuses 106 via the network 101. The replacement part information collection server 105 stores information on a replacement component replaced by the user through maintenance work. The information on the replacement part may be acquired from the image forming apparatus 106 or may be input by the user. The input device 103 is an input device used by the user. The user inputs actually performed response content from the input device 103, and transmits the response content to the image inspection result notification server 104 via the network 101.

The image inspection result notification server 104 is a server that creates and accumulates learning data and performs inspection based on the image anomaly information and the response content of the user. The image inspection result notification server 104 acquires various types of information via the network 101. The various types of information include feedback information transmitted by the input device 103, the image anomaly information held by the image anomaly information collection server 102, and information on a replacement part held by the replacement part information collection server 105. Learning data is created and accumulated based on the various types of received information.

Hereinafter, as an example, the image anomaly information collection server 102, the image inspection result notification server 104, and the replacement part information collection server 105 will be described as separate servers. The servers 102, 104, and 105 may be configured by one server, or may be configured by a plurality of servers by distributing the functions of the servers 102, 104, and 105. The configuration of the server is not limited to the form of FIG. 1.

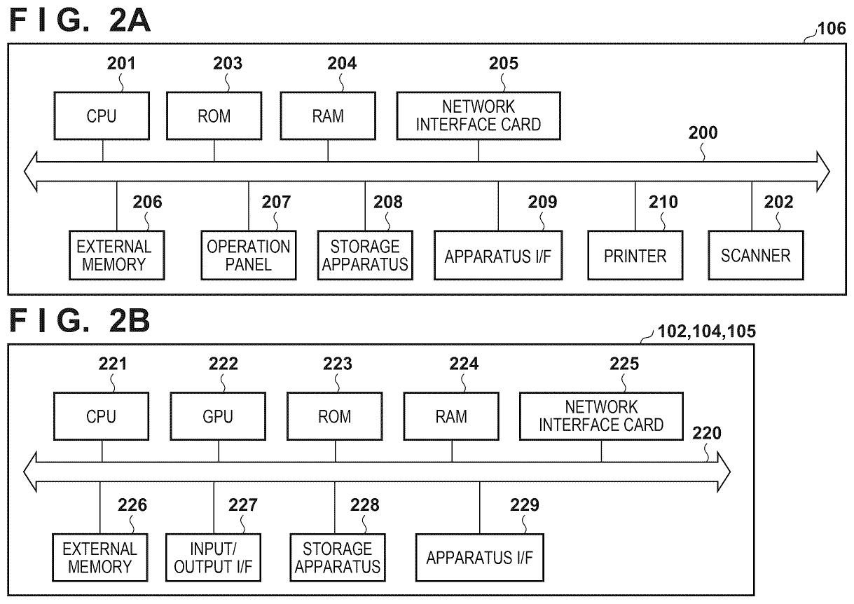

The hardware configuration of the image forming apparatus 106 according to an embodiment of the present invention will be described with reference to FIG. 2A. The image forming apparatus 106 includes a CPU 201, a ROM 203, a RAM 204, a network interface card 205, an external memory 206, an operation panel 207, a storage apparatus 208, an apparatus interface 209, a printer 210, and a scanner 202. Respective constituent elements are connected by a system bus 200.

The CPU 201 integrally controls access to various devices connected to the system bus 200. The CPU 201 performs control by reading, into the RAM 204, and executing a control program or the like stored in the ROM 203 or a control program, resource data (resource information), or the like stored in the external memory 206 connected via a disk controller or the like.

The ROM 203 stores various data such as programs such as a basic I/O program, font data used in document processing, and template data. The RAM 204 functions as a main memory, a work area, and the like of the CPU 201, and is configured such that the memory capacity can be expanded by an optional RAM connected to an expansion port not illustrated.

The network interface card 205 is an interface with an external apparatus, and the image forming apparatus 106 exchanges data with the external apparatus via the network interface card 205. The operation panel 207 displays a screen and receives a user operation instruction via the screen. A display portion such as a button and a liquid crystal panel for performing operations such as setting of an operation mode or the like of a printing apparatus, display of an operation status of the printing apparatus, and copy designation is also arranged.

The storage apparatus 208 is an external storage unit that functions as a large-capacity memory. The apparatus interface 209 is a connection interface with an external apparatus connectable by a USB or the like. The printer 210 uses a known printing technique, and suitable systems include an electrophotographic system (laser beam system), an inkjet system, and a sublimation (thermal transfer) system. As print data, the printer 210 prints, onto paper, image data converted from a page description language (PDL), a portable document format (PDF), or the like.

The scanner 202 uses a known image reading technique, and optically scans a paper document placed on a transparent top plate and converts the paper document into an image. A plurality of paper documents placed on an automatic document feeder (ADF) is continuously read and converted into an image. Hardware Configuration of Each Server

The hardware configurations of the image anomaly information collection server 102, the image inspection result notification server 104, the replacement component information collection server 105, and the operation information collection server 106 according to the embodiment of the present invention will be described with reference to FIG. 2B. The hardware configurations of the servers 102, 104, and 105 are basically the same.

The servers 102, 104, and 105 include a CPU 221, a GPU 222, a ROM 223, a RAM 224, a network interface card 225, an external memory 226, an input/output interface 227, a storage apparatus 228, and an apparatus interface 229. Respective constituent elements are connected by a system bus 220.

The CPU 221 controls the entire apparatus and integrally controls access to various devices connected to the system bus 220. The CPU 221 performs control by reading, into the RAM 224, and executing a control program or the like stored in the ROM 223 or a control program, resource data (resource information), or the like stored in the external memory 226 connected via a disk controller or the like. The GPU 222 is a computing apparatus specialized for vector computation such as image processing and machine learning.

The ROM 223 is a storage unit, and stores various data such as a basic I/O program. The RAM 224 is a RAM that functions as a main memory, a work area, or the like of the CPU 221 and the GPU 222, and is configured such that the memory capacity can be expanded by an optional RAM connected to an expansion port not illustrated.

The network interface card 225 is an interface with an external apparatus, and the server exchanges data with the external apparatus via the network interface card 225.

The input/output interface 227 can display a screen and receive a user operation instruction via an apparatus such as a display, a keyboard, a mouse, a smartphone, and a tablet.

The storage apparatus 228 is an external storage unit that functions as a large-capacity memory.

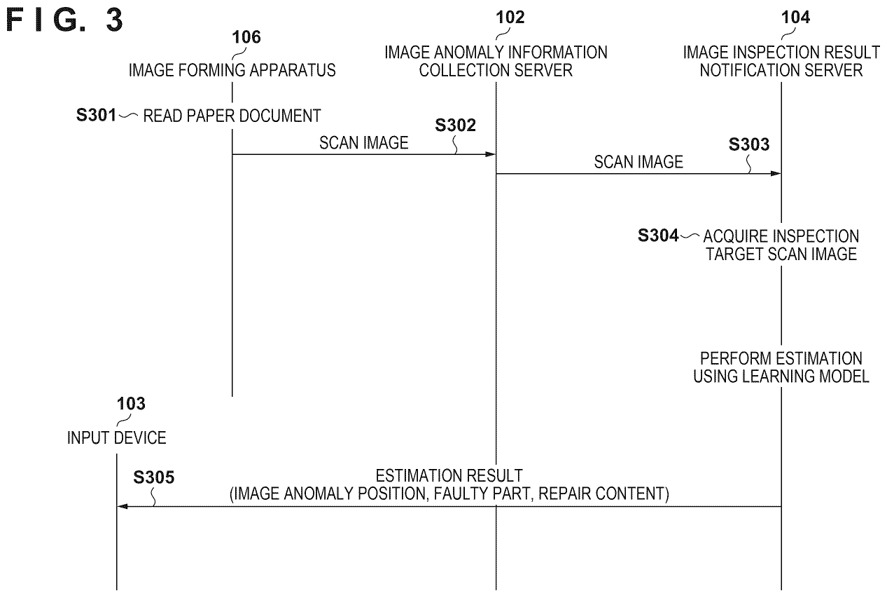

The apparatus interface 229 is a connection interface with an external apparatus connectable by a USB or the like. Hereinafter, an outline of the image inspection processing executed in the present embodiment will be described. FIG. 3 is a sequence diagram related to the image inspection processing indicated in the present embodiment. Hereinafter, the step number of each processing included in the sequence diagram is indicated by a number starting with “S”.

First, in S301, the CPU 201 reads a paper document by the scanner 202. The scanner 202 outputs, as a scan image 401, a real image on a paper document on which an image is printed by the image forming apparatus 106 or a printed test chart. For example, the operation panel 207 performs anomalous image reception for receiving a scan image having an image anomaly. The operation panel 207 displays a message prompting to operate a start button after setting the paper document in the scanner 202. By this, the user sets a paper document on the scanner 202 and operates the start button of the operation panel 207. Note that normally, when the paper document has an image anomaly, anomalous image reception is used. It is assumed that the user scans a paper document having an image anomaly through anomalous image reception from the image forming apparatus 106.

In S302, the CPU 201 acquires the scan image 401 obtained by reading the paper document.

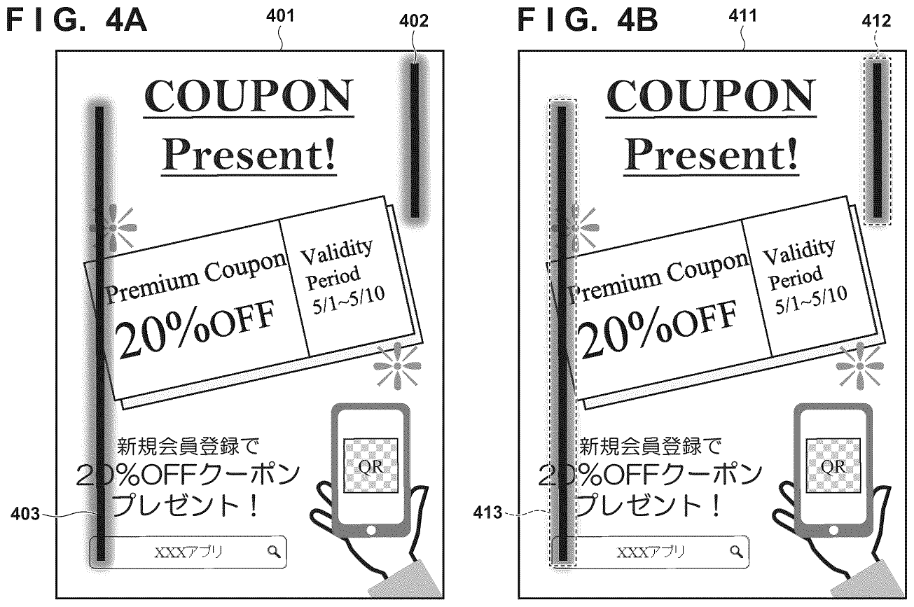

In S303, the CPU 201 transmits the scan image 401 and a time stamp (scan date and time information) to the image anomaly information collection server 102. FIG. 4A is an example of the scan image 401 for describing an anomalous image according to the present embodiment. Image anomalies 402 and 403 are image anomalies included in the scan image 401.

In S304, the CPU 221 of the image inspection result notification server 104 acquires the scan image 401 of the inspection target from the image anomaly information collection server 102.

In S305, using a trained learning model, the CPU 221 of the image inspection result notification server 104 estimates position information of the image anomaly included in the scan image 401, faulty part information that has caused the image anomaly, and corrective action content for the faulty part. That is, only by reading the paper document, the image forming apparatus 106 can estimate the position information of the image anomaly, the faulty part, and the corrective action content. Here, machine learning may be executed using deep learning or other known object detection algorithms (object detection models).

In machine learning, an image including an image anomaly is learned as training data. An image including an image anomaly such as the scan image 401 transmitted as an image anomaly is visually observed by the maintenance person, and an anomalous portion is surrounded by a pointing device or the like to specify a region having an anomaly. Then, the type of image anomaly is indicated for each region having an anomaly. The types of image anomaly include a circular anomaly (dirt (point)) and a streak-like anomaly (dirt (streak)). In this manner, it is possible to create a learning model that specifies an anomalous portion from an image.

Specification of an anomalous portion can also be performed by image recognition processing. Specification of an anomalous portion can be performed by comparing the anomalous image with a normally printed image or a RIP image. When there is one anomaly region in the image, the user may simply designate the type of image anomaly. When there are a plurality of anomaly regions, the user selects the region and specifies the type of anomaly in each region.

FIG. 4B is an example of an inspection image 411 for describing a result of executing the machine learning according to the present embodiment. The CPU 221 of the image inspection result notification server 104 outputs a bounding box 412 indicating the image anomaly 402, an image anomaly type “image anomaly”, and a confidence. Since the scan image 401 includes a plurality of image anomalies, a bounding box 413 indicating the image anomaly 403, the image anomaly type “image anomaly”, and the confidence are output. The bounding boxes 412 and 413 include region information for specifying a region indicating an image anomaly that should be detected. For example, position information on an image anomaly and region information indicating the type of the image anomaly are included. The confidence is the likelihood of a detection result, and is indicated by a numerical value of 0 to 100, for example.

When the bounding box and the image anomaly type included in the inspection image are erroneous, the user can correct them to give the learning model feedback learning. It is possible to increase the confidence of image inspection by feeding back a correct answer in the case of a correct answer.

As the corrective action content corresponding to the anomalous image, data in which the type of the image anomaly and the content of the corrective action performed by the user such as the maintenance person are associated with each other is used as training data. The user selects a bounding box included in the anomalous image and inputs the content of the corrective action. When there is one anomalous portion included in the anomalous image, it is not necessary to select a bounding box. If the anomalous image and the corrective action performed to cancel the anomalous image are associated with each other, the anomaly type is identified, and the corrective action content corresponding to the anomaly type is specified.

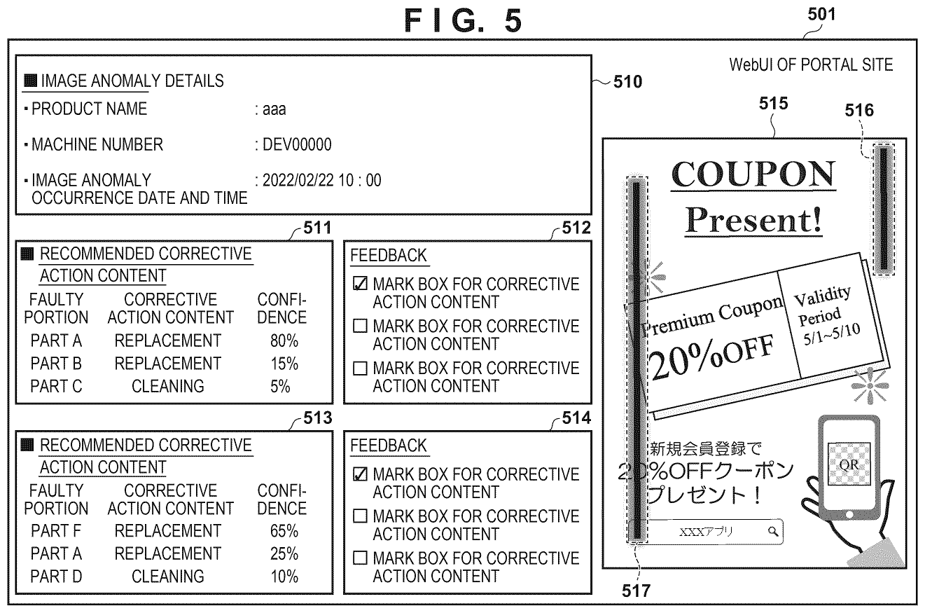

Display of the input device 103 will be described with reference to FIG. 5.

The display screen of the input device 103 displays a screen of a portal site 501. The portal site 501 is an example of a portal screen for inputting information to be transmitted to the image inspection result notification server 104. The portal site 501 includes an image anomaly detailed information display portion 510 of a target, recommended corrective action content display portions 511 and 513, feedback input portions 512 and 514, a scan image display portion 515, and image anomaly position information display portions 516 and 517.

The input device 103 is a terminal used by the user. The input device 103 may be a tablet terminal or a smartphone that the maintenance person holds when performing maintenance of the image forming apparatus 106. By scanning a paper document having an image anomaly through anomalous image reception with the image forming apparatus 106 of a maintenance target, the user can confirm the image anomaly and the recommended corrective action content by the input device 103 that is a tablet terminal.

The image anomaly detailed information display portion 510 displays a product name, a machine number, and image anomaly occurrence date and time. The product name is a product type of the image forming apparatus 106. The machine number is a unique ID attached to each image forming apparatus 106. The image anomaly occurrence date and time is the date and time when the image anomaly occurred.

The recommended corrective action content display portion 511 or 513 displays a faulty part candidate and a corrective action content candidate estimated to have a high possibility of resolving the event of the image anomaly in the image inspection result notification server 104 for each image anomaly. When one scan image 401 includes a plurality of image anomalies, a faulty part candidate and a corrective action content candidate are displayed for all the image anomalies. The recommended corrective action content may include replacement, cleaning, repair, and the like of a specific part. The display of the faulty part candidate and the corrective action content candidate may include the likelihood that the processing resolves the event based on an estimation result.

In the present embodiment, the CPU 201 of the image forming apparatus 106 transmits a scanned image read by the scanner 202 to the image anomaly information collection server 102 via the network 101. The CPU 221 of the image inspection result notification server 104 can execute image inspection processing of specifying type and position information of the image anomaly included in the scan image, a fault component candidate indicating the fault component that has caused the image anomaly, and a corrective action content candidate indicating the corrective action content for the fault component. The corrective action content for the fault component includes replacement, cleaning, adjustment, and repair of the fault component.

Hereinafter, an outline of the image inspection processing executed in the present embodiment will be described. FIG. 3 is a sequence diagram related to the image inspection processing indicated in the present embodiment. Hereinafter, the step number of each processing included in the sequence diagram is indicated by a number starting with “S”.

First, in S301, the CPU 201 reads a paper document by the scanner 202. The scanner 202 outputs, as a scan image 401, a real image on a paper document on which an image is printed by the image forming apparatus 106 or a printed test chart. For example, the operation panel 207 performs anomalous image reception for receiving a scanned image having an image anomaly. The operation panel 207 displays a message prompting to operate a start button after setting the paper document in the scanner 202. By this, the user sets a paper document on the scanner 202 and operates the start button of the operation panel 207. Note that normally, when the paper document has an image anomaly, anomalous image reception is used. It is assumed that the user scans a paper document having an image anomaly through anomalous image reception from the image forming apparatus 106.

In S302, the CPU 201 acquires the scan image 401 obtained by reading the paper document.

In S303, the CPU 201 transmits the scan image 401 and a time stamp (scan date and time information) to the image anomaly information collection server 102. FIG. 4A is an example of the scan image 401 for describing an anomalous image according to the present embodiment. Image anomalies 402 and 403 are image anomalies included in the scan image 401.

In S304, the CPU 221 of the image inspection result notification server 104 acquires the scan image 401 of the inspection target from the image anomaly information collection server 102.

In S305, using a trained learning model, the CPU 221 of the image inspection result notification server 104 estimates position information of the image anomaly included in the scan image 401, fault component information that has caused the image anomaly, and corrective action content for the fault component. That is, only by reading the paper document, the image forming apparatus 106 can estimate the position information of the image anomaly, the fault component, and the corrective action content. Here, machine learning may be executed using deep learning or other known object detection algorithms (object detection models).

In machine learning, an image including an image anomaly is learned as training data. An image including an image anomaly such as the scan image 401 transmitted as an image anomaly is visually observed by the maintenance person, and an anomalous portion is surrounded by a pointing device or the like to specify a region having an anomaly. Then, the type of image anomaly is indicated for each region having an anomaly. The types of image anomaly include a circular anomaly (dirt (point)) and a streak-like anomaly (dirt (streak)). In this manner, it is possible to create a learning model that specifies an anomalous portion from an image.

Specification of an anomalous portion can also be performed by image recognition processing. Specification of an anomalous portion can be performed by comparing the anomalous image with a normally printed image or a RIP image. When there is one anomaly region in the image, the user may simply designate the type of image anomaly. When there are a plurality of anomaly regions, the user selects the region and specifies the type of anomaly in each region.

FIG. 4B is an example of an inspection image 411 for describing a result of executing the machine learning according to the present embodiment. The CPU 221 of the image inspection result notification server 104 outputs a bounding box 412 indicating the image anomaly 402, an image anomaly type “image anomaly”, and a confidence. Since the scan image 401 includes a plurality of image anomalies, a bounding box 413 indicating the image anomaly 403, the image anomaly type “image anomaly”, and the confidence are output. The bounding boxes 412 and 413 include region information for specifying a region indicating an image anomaly that should be detected. For example, position information on an image anomaly and region information indicating the type of the image anomaly are included. The confidence is the likelihood of a detection result, and is indicated by a numerical value of 0 to 100, for example.

When the bounding box and the image anomaly type included in the inspection image are erroneous, the user can correct them to give the learning model feedback learning. It is possible to increase the confidence of image inspection by feeding back a correct answer in the case of a correct answer.

As the corrective action content corresponding to the anomalous image, data in which the type of the image anomaly and the content of the corrective action performed by the user such as the maintenance person are associated with each other is used as training data. The user selects a bounding box included in the anomalous image and inputs the content of the corrective action. When there is one anomalous portion included in the anomalous image, it is not necessary to select a bounding box. If the anomalous image and the corrective action performed to cancel the anomalous image are associated with each other, the anomaly type is identified, and the corrective action content corresponding to the anomaly type is specified.

Display of the input device 103 will be described with reference to FIG. 5.

The display screen of the input device 103 displays a screen of a portal site 501. The portal site 501 is an example of a portal screen for inputting information to be transmitted to the image inspection result notification server 104. The portal site 501 includes an image anomaly detailed information display portion 510 of a target, recommended corrective action content display portions 511 and 513, feedback input portions 512 and 514, a scan image display portion 515, and image anomaly position information display portions 516 and 517.

The input device 103 is a terminal used by the user. The input device 103 may be a tablet terminal or a smartphone that the maintenance person holds when performing maintenance of the image forming apparatus 106. By scanning a paper document having an image anomaly through anomalous image reception with the image forming apparatus 106 of a maintenance target, the user can confirm the image anomaly and the recommended corrective action content by the input device 103 that is a tablet terminal.

The image anomaly detailed information display portion 510 displays a product name, a machine number, and image anomaly occurrence date and time. The product name is a product type of the image forming apparatus 106. The machine number is a unique ID attached to each image forming apparatus 106. The image anomaly occurrence date and time is the date and time when the image anomaly occurred.

The recommended corrective action content display portion 511 or 513 displays a fault component candidate and a corrective action content candidate estimated to have a high possibility of resolving the event of the image anomaly in the image inspection result notification server 104 for each image anomaly. When one scan image 401 includes a plurality of image anomalies, a fault component candidate and a corrective action content candidate are displayed for all the image anomalies. The recommended corrective action content may include replacement, cleaning, repair, and the like of a specific component. The display of the fault component candidate and the corrective action content candidate may include the likelihood that the processing resolves the event based on an estimation result.

In the example of the recommended corrective action content display portion 511, regarding the image abnormal position information display portion 516 of the scan image display portion 515, the likelihood of resolving the anomaly by replacing a component A is 80%, the likelihood thereof by replacing a component B is 15%, and the likelihood thereof by cleaning a component C is 5%.

The feedback input portion 512 is a screen for inputting feedback information. The corrective action content that has actually solved the anomalous phenomenon is input as feedback information. The input method may be a selection form such as a check box or a free input form with characters. When a plurality of image anomalies exist in one scan image 401, feedback information is input for all the image anomalies.

In the example of the feedback input portion 512, the component A displayed on the recommended corrective action content display portion 511 is replaced with respect to an image abnormal position information display portion 516 of the scan image display portion 515.

The scan image display portion 515 is a display portion that displays the scan image 401 transmitted from the user, and displays an anomaly region in a rectangular shape when there is an image anomaly. When a plurality of image anomalies exist in one scan image 401, a rectangle is displayed in the regions for all the image anomalies. The example of the scan image display portion 515 of FIG. 5 indicates existence of bounding boxes 516 and 517 in which an anomaly region included in the scan image display portion 515 is displayed in a rectangular shape.

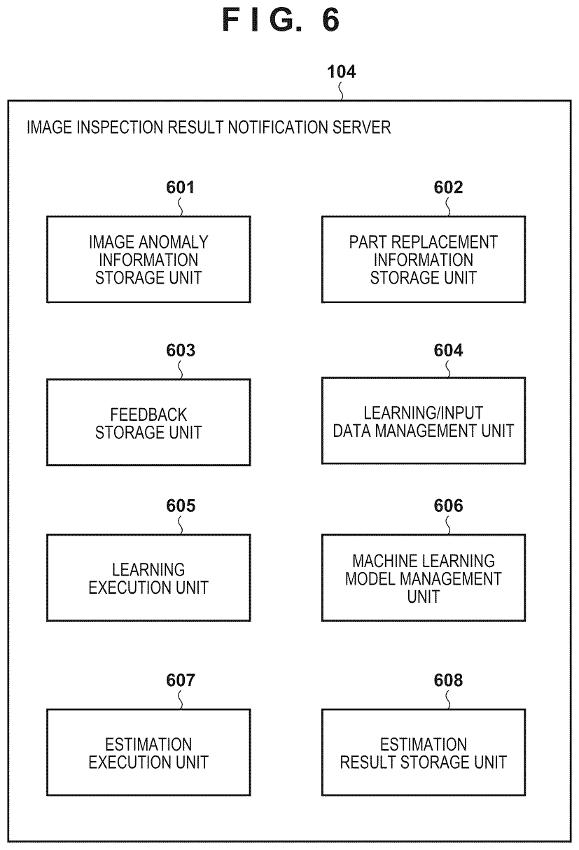

The software configuration of the image inspection result notification server 104 of the present invention will be described with reference to FIG. 6. A program of the image inspection result notification server 104 is read from the RAM 224, the storage apparatus 228, a secondary storage apparatus connected via the apparatus interface 229, and the like, and is implemented by being executed by the CPU 221 or the GPU 222 of the image inspection result notification server 104. Access to the outside of the image anomaly information collection server 102, the input device 103, and the like is performed via the network interface card 225.

The image inspection result notification server 104 includes, as data storage units, the image anomaly information storage unit 601, a component replacement information storage unit 602, and a feedback storage unit 603. The image inspection result notification server 104 includes, as functional units of software, a learning/input data management unit 604, a learning execution unit 605, a machine learning model management unit 606, an estimation execution unit 607, and an estimation result storage unit 608.

The image anomaly information storage unit 601 stores image anomaly information and the like of the image forming apparatus 106 received by the CPU 221 of the image inspection result notification server 104 from the image anomaly information collection server 102 via the network 101.

The component replacement information storage unit 602 stores replacement component information received by the CPU 221 of the image inspection result notification server 104 from the replacement component information collection server 105 via the network 101.

The feedback storage unit 603 receives and stores, via the network 101, feedback information input by the CPU 221 of the image inspection result notification server 104 through the feedback input portions 512 and 514 of the input device 103.

The learning/input data management unit 604 creates and stores learning data and input data based on each element information stored in the image inspection result notification server 104. Each piece of element information includes the following information.
Image anomaly information held in the image anomaly information storage unit 601
Replacement component information held by the component replacement information storage unit 602
Feedback information held by the feedback storage unit 603

The learning/input data management unit 604 creates and stores learning data when the CPU 221 of the image inspection result notification server 104 learns a machine learning model, and creates and stores input data when the CPU 221 of the image inspection result notification server 104 performs estimation using the machine learning model.

In the learning execution unit 605, the CPU 221 of the image inspection result notification server 104 acquires learning data from the learning/input data management unit 604, executes learning based on a machine learning algorithm designated in advance, and creates a machine learning model. The CPU 221 of the image inspection result notification server 104 stores the created machine learning model into the machine learning model management unit 606. Note that the machine learning model may be recreated (retrained) by repeatedly executing learning in accordance with a change in the learning data stored in the learning/input data management unit 604.

The machine learning model management unit 606 stores the machine learning model that the CPU 221 of the image inspection result notification server 104 created by the learning execution unit 605. Note that the machine learning model used for estimation may be replaced by using, as a trigger, reception of the machine learning model from the learning execution unit 605, condition determination in the machine learning model management unit 606, or the like. For example, when the correct answer rate of a new machine learning model exceeds a certain level, the new machine learning model may be replaced with the current machine learning model.

The estimation execution unit 607 executes estimation by the CPU 221 of the image inspection result notification server 104 acquiring input data from the learning/input data management unit 604 and inputting the input data to the machine learning model stored in the machine learning model management unit 606.

The estimation result storage unit 608 stores the result of the estimation that the CPU 221 of the image inspection result notification server 104 executed by the estimation execution unit 607. The estimation result storage unit 608 also transmits the estimation result to the input device 103 via the network 101. Alternatively, a request from the input device 103 may be received via the network 101, and an estimation result may be returned. The input device 103 displays the estimation result on the portal screen as illustrated in the recommended corrective action content display portions 511 and 513 and the scan image display portion 515. In the example of the bounding box 516 of the scan image display portion 515 and the recommended corrective action content display portion 511, in the recommended corrective action content of the bounding box 516, the likelihood of the component A is 80%, the likelihood of the component B is 15%, and the likelihood of the component C is 5%.

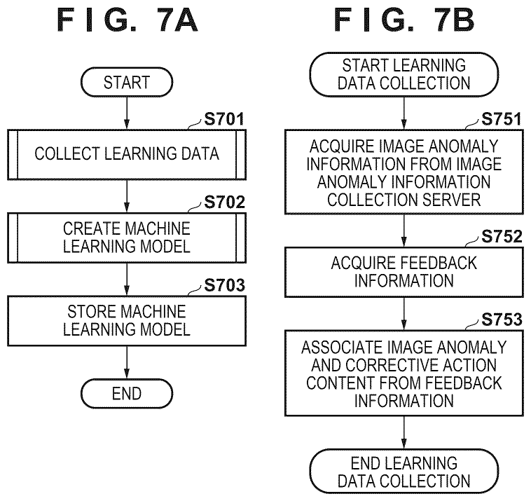

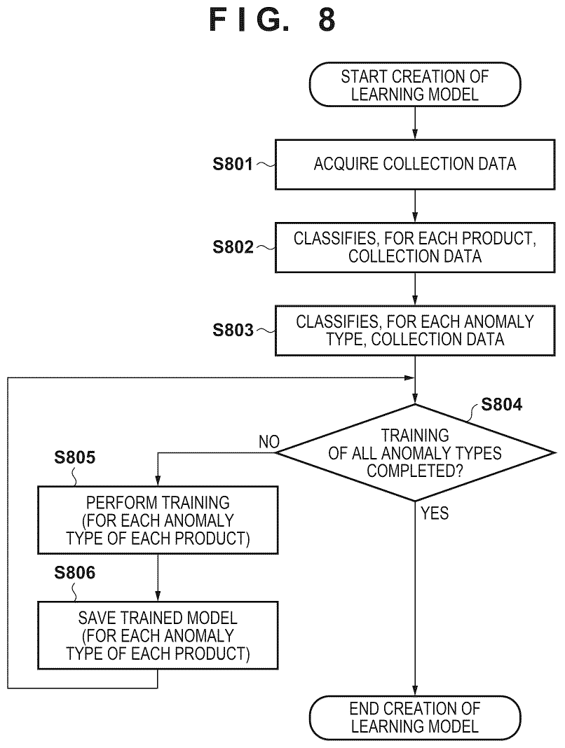

With reference to FIGS. 7A and 7B and FIG. 8, a proposed technique shown in the present embodiment will be described.

FIG. 7A is an overall flowchart of the image inspection result notification server 104 in the present embodiment. The processing of FIGS. 7A and 7B and FIG. 8 is implemented, for example, by the CPU 221 or the GPU 22 of the image inspection result notification server 104 reading a program stored in the ROM 223 or the external memory 226 into the RAM 224 and executing the program. Hereinafter, the step number of each process included in the flowchart is indicated by a number starting with “S”. The same applies to the subsequent flowcharts.

First, in S701, the CPU 221 of the image inspection result notification server 104 collects learning data by the learning/input data management unit 604. Next, in S702, the CPU 221 of the image inspection result notification server 104 creates a machine learning model by the learning execution unit 605 using the collected learning data. Finally, in S703, the CPU 221 of the image inspection result notification server 104 stores the created machine learning model into the machine learning model management unit 606.

In the image forming apparatus 106, when an image anomaly occurs, the image inspection result notification server 104 receives a notification from the image forming apparatus 106. The CPU 221 of the image inspection result notification server 104 estimates the corrective action content by the estimation execution unit 607 using the machine learning model created in the flow of FIG. 7A. The CPU 221 of the image inspection result notification server 104 transmits the estimation result to the input device 103. The portal site 501 is displayed on the input device 103, and the user can confirm the portal site 501. The user can input feedback information via the portal site 501 displayed on the input device 103. For example, the portal site 501 receives inputs of feedback information 512 for the bounding box 516 and feedback information 514 for the bounding box 517. The CPU 221 of the image inspection result notification server 104 saves, into the feedback storage unit 603, the received feedback information 512 and 514.

FIG. 7B is a flowchart showing details of the learning data collection of the image inspection result notification server 104 in the present embodiment of S701 of FIG. 7A.

In S751, the CPU 221 of the image inspection result notification server 104 acquires image anomaly information from the image anomaly information collection server 102 and stores it into an image anomaly information storage unit 701. An example of image anomaly information collected by the image anomaly information collection server 102 is shown in Table 1. The product name is a product type of the image forming apparatus 106. The machine number is a unique ID for specifying each image forming apparatus 106. The scan image transmission date and time is the date and time when the user transmitted the scan image. The scan image ID is a unique ID attached to each transmitted scan image. The image anomaly ID is a unique character string code for recognizing an image anomaly included in the transmitted scan image.

For example, the first line of Table 1 has a meaning that “Regarding the machine number DEV0001 of the product name PRO1001, the user transmitted the scan image ID SCA0001, 2022/02/01 10:00. The image anomaly ID is IMA1001.”

TABLE 1
IMAGE ANOMALY INFORMATION

| | | SCAN IMAGE | SCAN | IMAGE |
|---|---|---|---|---|
| PRODUCT | MACHINE | TRANSMISSION | IMAGE | ANOMALY |
| NAME | NUMBER | DATE AND TIME | ID | ID |
| PRO1001 | DEV0001 | 2022 Feb. 1 10:00 | SCA0001 | IMA1001 |
| PRO1001 | DEV0001 | 2022 Feb. 1 10:00 | SCA0001 | IMA1002 |

An example of bounding box information for the image anomaly is shown in Table 2. The scan image ID is a unique ID attached to each transmitted scan image. The image anomaly ID is a unique character string code for recognizing an image anomaly included in the transmitted scan image. The X coordinate and the Y coordinate are vertex coordinates (pixel values) at the upper left of the bounding box, and the height and the width are the height and the width (pixel values) of the bounding box. In the example of Table 2, there are two image anomalies in the image data of the scan image ID “SCA0001”, and two pieces of bounding box information corresponding to the two image anomalies are included.

TABLE 2
BOUNDING BOX INFORMATION

| SCAN | IMAGE | X | Y | | |
|---|---|---|---|---|---|
| IMAGE | ANOMALY | COOR- | COOR- | | |
| ID | ID | DINATE | DINATE | HEIGHT | WIDTH |
| SCA0001 | IMA1001 | 100 | 150 | 50 | 30 |
| SCA0001 | IMA1002 | 200 | 500 | 60 | 30 |

Next, in S752, the CPU 221 of the image inspection result notification server 104 acquires feedback information of the machine number from the feedback storage unit 603. An example of the feedback information is shown in Table 3.

The product name is a product type of the image forming apparatus 106. The machine number is a unique ID attached to each image forming apparatus 106. The corrective action date and time is the date and time when the user performed corrective action. The scan image ID is a unique ID attached to each transmitted scan image. The image anomaly ID is a unique character string code for recognizing an image anomaly included in the transmitted scan image. The corrective action content is the name of the corrective action content actually performed by the user. The fault component is the name of a component actually repaired or replaced by the user.

For example, the first line of Table 3 has a meaning that “Regarding the machine number DEV0001 of the product name PRO1001, the component A was replaced for the image anomaly ID IMA1001 on the scan image ID SCA0001, 2022/02/03 14:02”.

TABLE 3
FEEDBACK INFORMATION

| | | CORRECTIVE | | | | |
|---|---|---|---|---|---|---|
| | | ACTION | SCAN | IMAGE | CORRECTIVE | |
| PRODUCT | MACHINE | DATE AND | IMAGE | ANOMALY | ACTION | FAULT |
| NAME | NUMBER | TIME | ID | ID | CONTENT | COMPONENT |
| SCA0001 | DEV0001 | Mar. 2, 2022 | SCA0001 | IMA1001 | REPLACEMENT | COMPONENT A |
| | | 14:02 | | | | |
| SCA0001 | DEV0001 | Mar. 2, 2022 | SCA0001 | IMA1002 | CLEANING | COMPONENT F |
| | | 14:02 | | | | |

In S753, the CPU 221 of the image inspection result notification server 104 associates the scan image ID, the image anomaly ID, the fault component, and the corrective action content from the feedback information in the feedback storage unit 404. Table 4 shows data of corrective action for the fault that is a result of associating the scan image ID, the image anomaly ID, the fault component, and the corrective action content from the feedback information.

The product name in the data of corrective action for the fault in Table 4 is the product type of the image forming apparatus 106. The scan image ID is a unique ID attached to each transmitted scan image. The image anomaly ID is a unique character string code for recognizing an image anomaly of the transmitted scan image. The X coordinate and the Y coordinate are vertex coordinates (pixel values) at the upper left of the bounding box, and the height and the width are the height and the width (pixel values) of the bounding box. The corrective action content is the name of the corrective action content actually performed by the user. The fault component is the name of a component actually repaired or replaced by the user.

TABLE 4
LEARNING DATA ASSOCIATED WITH POSITION INFORMATION, CORRECTIVE
ACTION CONTENT, AND FAULT COMPONENT FOR IMAGE ANOMALY

| | SCAN | IMAGE | X | Y | | | CORRECTIVE | |
|---|---|---|---|---|---|---|---|---|
| PRODUCT | IMAGE | ANOMALY | COORDI- | COORDI- | | | ACTION | FAULT |
| NAME | ID | ID | NATE | NATE | HEIGHT | WIDTH | CONTENT | COMPONENT |
| PRO1001 | SCA0001 | IMA1001 | 100 | 150 | 50 | 30 | REPLACEMENT | COMPONENT A |
| PRO1001 | SCA0001 | IMA1002 | 200 | 500 | 60 | 30 | CLEANING | COMPONENT F |

The present embodiment enables association of the image anomaly occurred in the image forming apparatus 106, the corrective action content performed to resolve the image anomaly, and the fault component. This can provide a mechanism for using, as learning data, the data of corrective action for the fault including information on the corrective action performed by the user, for the type of fault of the apparatus (type of image anomaly of the image forming apparatus).

FIG. 8 is a flowchart showing an example of a creation step of the machine learning model of the image inspection result notification server 104 in the present embodiment corresponding to S702 of FIG. 7A.

In S801, the CPU 221 of the image inspection result notification server 104 uses, as collection data, the scan image held by an image anomaly information storage unit 601, the replacement part information held by a part replacement information storage unit 602, and the fault corrective action data derived from Table 4. Any one of the replacement part information and the fault corrective action data derived from Table 4 may be used.

In S802, the CPU 221 of the image inspection result notification server 104 classifies, for each product, the collection data acquired in S801.

In S803, the CPU 221 of the image inspection result notification server 104 classifies, for each anomaly type, the collection data classified for each product in S802. The learning data is a scan image, and abnormal position information and an anomaly type of an anomaly included in the scan image. The learning data is replacement part information held by the part replacement information storage unit 602. This can associate the scan image and the replacement part. The learning data is fault corrective action data derived from Table 4, that is, the corrective action content associated with the anomaly type of the scan image and the fault information of the faulty part.

In S804 to S806, the CPU 221 of the image inspection result notification server 104 performs training of the learning model for each anomaly type of each product using the learning data generated in S803. In S804, it is determined whether training of learning models of all anomaly types has been performed. If the training of learning models of all anomaly types is not ended (No), the process proceeds to S805. If the training of learning models of all anomaly types is ended (Yes), the flow ends. The learning of S805 and S806 is repeated until the training of learning models of all anomaly types is ended. In the present embodiment, training of the learning model is performed for each anomaly type of each product, but training of the learning model may be collectively performed for a plurality of anomaly types of each product.

In S805, using an object detection algorithm, the CPU 221 of the image inspection result notification server 104 performs training of the learning model related to the scan image for each image anomaly type of each product generated in S803. As the object detection algorithm, an algorithm called a known detection transformer (DETR) can be used. For example, a bounding box that is a frame including an object is estimated using a convolutional neural network. Then, the confidence that the bounding box includes an object and the probability for each type of object when the bounding box includes an object are predicted. In learning, a learning result is evaluated by cross verification in which learning data is randomly divided into analysis data and verification data. This can create a learning model for estimating the inspection image 411 of FIG. 4B.

Here, the machine learning algorithm has various methods. Various object detection models can be used to detect a rectangular region indicating an image (e.g., image anomaly) of a focused target object. For example, there are You Only Look Once (YOLO), Single Shot MultiBox Detector (SSD), Region Based Convolutional Neural Networks (R-CNN), and the like. Hyperparameters of the machine learning algorithm also vary depending on the machine learning algorithm. In the present embodiment, the machine learning algorithm, the evaluation technique of the learning result, the optimization method of the hyperparameters of the machine learning algorithm, and the like can be appropriately changed.

In machine learning, training is performed to associate an anomaly type of the inspection image with a part that has caused the anomaly and corrective action content performed to resolve the anomaly. In the above description, the fault corrective action data derived from Table 4 is used as the learning data. However, in the initial state in which the feedback information of Table 3 is not accumulated, it is necessary for the user to create fault corrective action data in which the anomaly type of the inspection image, the part that has caused the anomaly, and the corrective action content for resolving the anomaly are associated with one another. Then, the created data of fault corrective action for the fault is used as learning data.

Creation of learning data by the user will be described.

The user specifies the anomaly type and the anomalous portion in the scan image including the anomaly, and associates the faulty part with the corrective action content for the anomaly type. If there is one anomalous portion in the scan image, it is possible to automatically associate the faulty part and the corrective action content or the replacement component information with respect to the anomaly type.

If there are a plurality of anomalous portions in the scan image, the anomaly types may be different. There is a case where a difference in anomaly type causes a difference in components causing the anomalies, and a plurality of faulty parts or replacement components may correspond to one scan image. In such a case, the user creates data of corrective action for the fault by associating the faulty part and the corrective action content or the replacement component information with the region of the anomalous image of the scan image while confirming the scan image. Then, the created corrective action data is used as learning data for creating a learning model.

In S806, the CPU 221 of the image inspection result notification server 104 saves the trained model trained in S805 into a file and registers it into a machine learning model management unit 606.

Here, the file saving the trained model includes the type of the learning algorithm and the value of the hyperparameter of the learning algorithm.

### Second Embodiment

The First Embodiment assumes that the user gives feedback on an image anomaly with the web UI of the portal site. However, there may be a case where the user erroneously inputs the feedback record. Since the feedback information is the most important information in the First Embodiment, there is a possibility that the accuracy of the machine learning model decreases if the erroneously input feedback information is used.

In the Second Embodiment, attention is paid to the fact that when the user erroneously inputs a part having no relation as feedback information, the replacement part included in the feedback information is not included in the replacement part information actually replaced by the user. For example, in the feedback information in Table 5 and the replacement part information in Table 6, it can be seen that a replacement part (part F) included in the feedback information in Table 5 is not included in a replacement part (part A and part D) included in the replacement part information of the user in Table 6.

TABLE 5
FEEDBACK INFORMATION

| | | CORRECTIVE | IMAGE | CORREC- | |
|---|---|---|---|---|---|
| PRO- | | ACTION | ANO- | TIVE | |
| DUCT | MACHINE | DATE AND | MALY | ACTION | FAULTY |
| NAME | NUMBER | TIME | ID | CONTENT | PART |
| PRO1001 | DEV0001 | 2022 Feb. 3 | IMA1001 | RE- | PART |
| | | 14:02:00 | | PLACEMENT | A |
| PRO1001 | DEV0001 | 2022 Feb. 3 | IMA1002 | CLEANING | PART F |
| | | 14:02:00 | | | |

TABLE 6
REPLACEMENT PART INFORMATION

| PRODUCT | MACHINE | REPLACEMENT | FAULTY |
|---|---|---|---|
| NAME | NUMBER | DATE AND TIME | PART |
| PRO1001 | DEV0001 | 2022 Feb. 3 14:02:00 | PART A |
| PRO1001 | DEV0001 | 2022 Feb. 3 14:02:00 | PART D |

In the Second Embodiment, when the replacement part included in the feedback information in the First Embodiment is not included in the replacement part information, it is determined that the reliability of the information on the replacement part included in the feedback information is low, and the feedback information is not used for machine learning.

A system configuration diagram (FIG. 1), a hardware configuration diagram (FIGS. 2A and 2B), an input device screen example diagram (FIG. 5), and a software configuration diagram (FIG. 6) of the Second Embodiment are similar to those of the First Embodiment, and thus descriptions thereof are omitted. The entire flowchart (FIG. 7A) of the image inspection result notification server 104 is similar to that of the First Embodiment, and thus the description thereof is omitted.

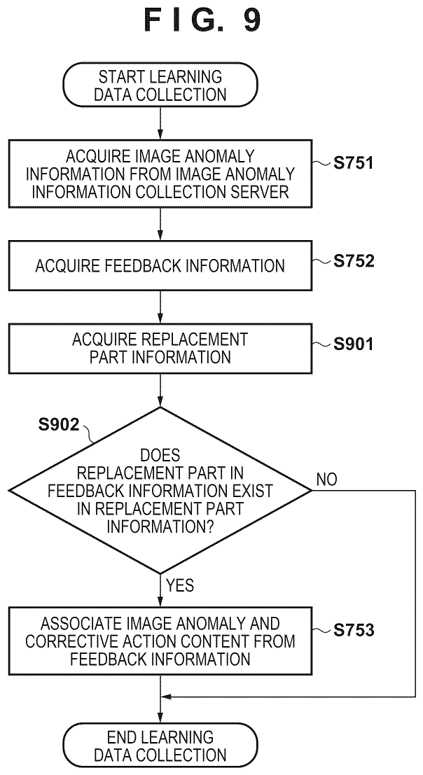

FIG. 9 is a flowchart showing details of learning data collection step S701 of the image inspection result notification server 104 in the Second Embodiment. The processing of FIG. 9 is implemented, for example, by the CPU 221 or the GPU 22 of the image inspection result notification server 104 reading and executing a program stored in a ROM 223 or an external memory 226 into a RAM 224.

Steps S751 and S752 in FIG. 9 are similar to steps S751 and S752 shown in FIG. 7B. In S901, the CPU 221 of the image inspection result notification server 104 acquires replacement part information from the replacement part information collection server 105 and stores the replacement part information into the part replacement information storage unit 602.

In S902, it is determined whether or not a replacement part included in the feedback information exists in the replacement part information. If the replacement part included in the feedback information exists in the replacement part information (Yes), the process proceeds to S753. The processing of S753 shown in FIG. 9 is similar to S753 shown in FIG. 7B. In S902, if the replacement part included in the feedback information does not exist in the replacement part information (No), it is determined that there is an input error in the user's feedback information, and the feedback information is not used as the machine learning data.

In the Second Embodiment, by comparing the feedback information with the replacement part information, it is possible to appropriately associate an image anomaly generated in the image forming apparatus and the corrective action content for solving the image anomaly. It is possible to suppress erroneous association due to erroneous input by the user. This can provide a mechanism for promoting collection of learning data including an appropriate response for an image anomaly.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-041589, filed Mar. 15, 2024 which is hereby incorporated by reference herein in its

What is claimed is:

1. An image inspection apparatus, comprising:
an acquiring unit configured to acquire information on a corrective action performed by a user for an image anomaly; and
a training unit configured to perform training of a learning model for estimating a candidate of corrective action content from an image anomaly using, as learning data, the image anomaly and the acquired information on the corrective action.

2. The image inspection apparatus according to claim 1, further comprising
an estimation unit configured to estimate a candidate of corrective action content for an image anomaly by the learning model,
wherein the acquiring unit acquires information on a corrective action performed by the user from the estimated candidate of the corrective action content.

3. The image inspection apparatus according to claim 1, wherein the candidate of the corrective action content includes information on a faulty part.

4. The image inspection apparatus according to claim 2,
wherein the candidate of the corrective action content includes information on a faulty part and a confidence of the corrective action content.

5. The image inspection apparatus according to claim 1, further comprising
a transmitting unit configured to transmit, to an input device, the estimated candidate of the corrective action content,
wherein the acquiring unit acquires information on a corrective action performed by the user from the input device.

6. The image inspection apparatus according to claim 1, further comprising
a determining unit configured to determine whether or not information on a replacement part included in the acquired corrective action exists in actually replaced part information,
wherein if the determining unit determines that the information does not exist, the information is not used as the learning data.

7. A method for image inspection, the method comprising:
acquiring information on a corrective action performed by a user for an image anomaly; and
performing training of a learning model for estimating a candidate of corrective action content from an image anomaly using, as learning data, the image anomaly and the acquired information on the corrective action.

8. A non-transitory computer-readable storage medium, the storage medium storing a program for causing a computer to execute each step of a method of controlling an image inspection apparatus, the method comprising:
acquiring information on a corrective action performed by a user for an image anomaly; and
performing training of a learning model for estimating a candidate of corrective action content from an image anomaly using, as learning data, the image anomaly and the acquired information on the corrective action.
